(19) United States
(12) Patent Application Publication
(10) Pub. No.: US 2006/0138864 A1
(43) Pub. Date: Jun. 29, 2006

(54) Illuminating key fob

(76) Inventor: Mark Trahanovsky, Yorba Linda, CA (US)

Correspondence Address: MICHAEL A. SHIPPEY, PH. D., 4848 LAKEVIEW AVENUE, SUITE B, YORBA LINDA, CA, 92886, US

(21) Appl. No.: 11/022,203

(22) Filed: Dec. 23, 2004

(51) Int. Cl. B60L 1/00

(52) U.S. Cl. 307/10.1

(57) ABSTRACT

The present invention incorporates a key fob with rows of lights, and an intelligent controller. The lights are set up to simulate a popular lighting display. In one embodiment, the lights mimic the “Christmas tree” lighting system used to start racing cars. Space is available on the fob for an optional decal or logo. Optionally, sound effects may be included, for example to mimic the sound of race car engines.

The present invention incorporates a key fob with rows of lights, and an intelligent controller. The lights are set up to simulate a popular lighting display. In one embodiment, the lights mimic the “Christmas tree” lighting system used to start racing cars. Space is available on the fob for an optional decal or logo. Optional sound effects are included.

### BACKGROUND

The present invention is a key fob with rows of lights, and an intelligent controller. It is related to small novelty devices that have colored glass or lights, sometimes flashing. It includes, optionally, sound effects.

In the prior art, key fobs are often used in conjunction with automobile entry systems. Thus, these fobs act as controller units, not just visual display devices. In fact, many of the prior art key fobs comprise no lights whatsoever. Those that do include lights, such as LEDs, use these for indicators of functionality. Thus, a prior art key fob may use one color of light to indicate an unlocking function, and another color to indicate a trunk opening function.

Key fobs rarely have sound effects included. Such sounds as they can emit are actually produced by the automobile, in response to commands issued by the key fob controller.

With the advent of miniature electronic systems, it is now possible to mimic known lighting systems in miniature, and incorporate the lighting design in a key fob. One such lighting system is the popular “Christmas tree” lighting system used to start national and international drag races. This system has been patented in U.S. Pat. No. 6,695,460, issued on Feb. 24, 2004 to inventor Warner. Other lighting systems include the lighting perimeter around an airport runway system, the San Francisco skyline at night, and so forth.

It is an object of the present invention to provide a source of entertainment for the user, with flashing lights and optional sound.

It is another object of the present invention to provide a small source of light for illuminated limited areas.

It is yet another object of the present invention to mimic well known lighted systems in miniature, such as the lights and sounds of a drag race.

It is still another object of the present invention to provide a sense of direction from one person to another at night or in darkened areas.

Further uses of the present invention will become obvious upon the reading of the attached specification and claims, in conjunction with the drawings supplied.

### BRIEF DESCRIPTION OF THE DRAWINGS

The many objects and advantages of the present invention will become apparent from the following descriptions, taken in connection with the accompanying drawings, wherein, by way of illustration and example, an embodiment of the present invention is disclosed.

FIG. 1 displays a preferred embodiment of the present invention from a front perspective view.

FIG. 2 reveals a slightly altered second embodiment of the present invention from a frontal view.

FIG. 3 shows the back side of the second embodiment of the present invention.

FIGS. 4A through 4E depict the separated top half of the present invention from various angles of view.

FIGS. 5A through 5E depict the disassembled bottom half of the present invention from various angles of view.

FIG. 6 is the circuit diagram for an embodiment of the current invention.

The drawings constitute a part of this specification and include exemplary embodiments to the invention, which may be embodied in various forms. It is to be understood that in some instances various aspects of the invention may be shown exaggerated or enlarged to facilitate an understanding of the invention.

### DETAILED DESCRIPTION OF THE INVENTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as representative basis for teaching one skilled in the art to employ the present invention in virtually any appropriately detailed system, structure or manner.

The present invention comprises a key fob with rows of lights, and an intelligent controller. The lights are set up to simulate a popular lighting display. The user can select from among a series of orders of lighting, to simulate different light systems.

In one preferred embodiment, the lights mimic the “Christmas tree” lighting system used to start racing cars. This embodiment is depicted in the accompanying figures.

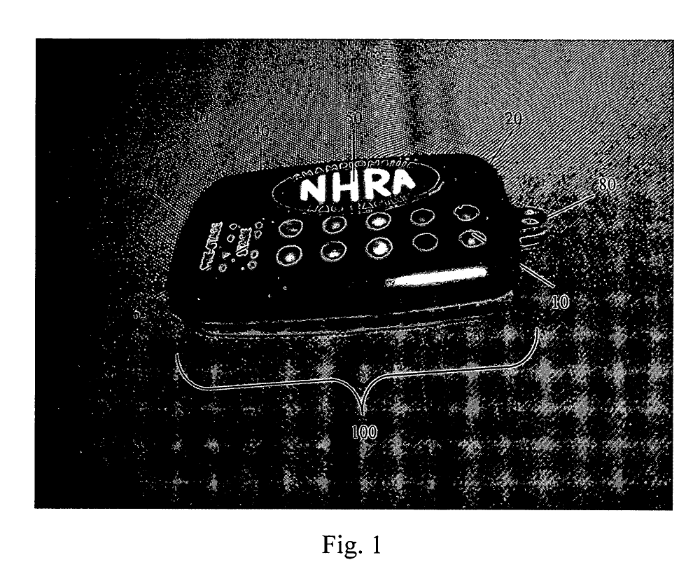

The portrayed embodiment 100 of the current invention is seen in FIG. 1 from a perspective overhead view. On top can be seen the two rows of LED lights 10 and 20. These end with two perpendicular rows of smaller lights, 30 and 40. Surrounding the upper of these two rows of tiny lights are two small patches 60 and 65. These could house buttons for further controls, but in this embodiment are used for labeling the light functions.

Additionally in FIG. 1 is shown a large area 50 for decal or similar display. In this rendition, the decal of the NHRA, a national car racing association, is displayed. This is an appropriate decal for the lighting display of the current embodiment, as will be described below. Finally, in this view is seen the attachment loop 80 for attachment of a key ring.

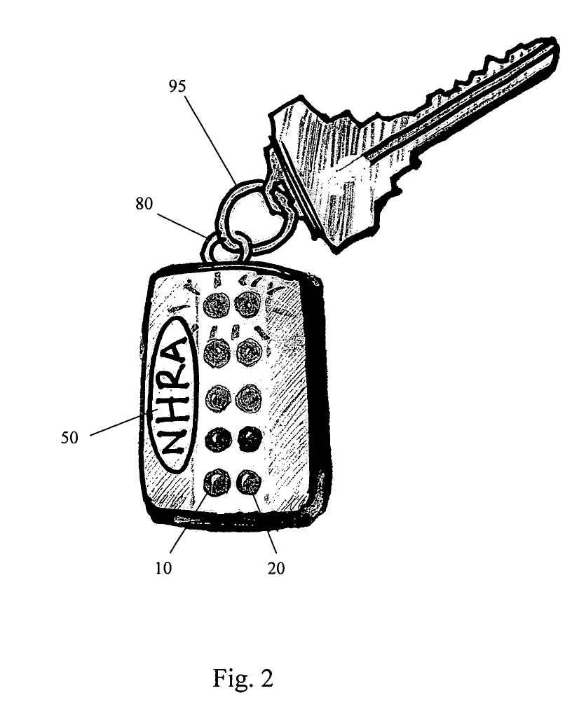

FIG. 2 presents a slightly altered embodiment of the current invention. This is a slightly smaller version, which has the dual rows of lights 10, 20 and decal area 50 and loop 80 for key ring. However, it omits the smaller lights and the patch areas shown in the first figure. The controls for the lights in this embodiment are on the back side of the unit (shown not in this figure, but in later figures). Key 90 and key ring 95 are shown for utility purposes, but are not part of the current invention.

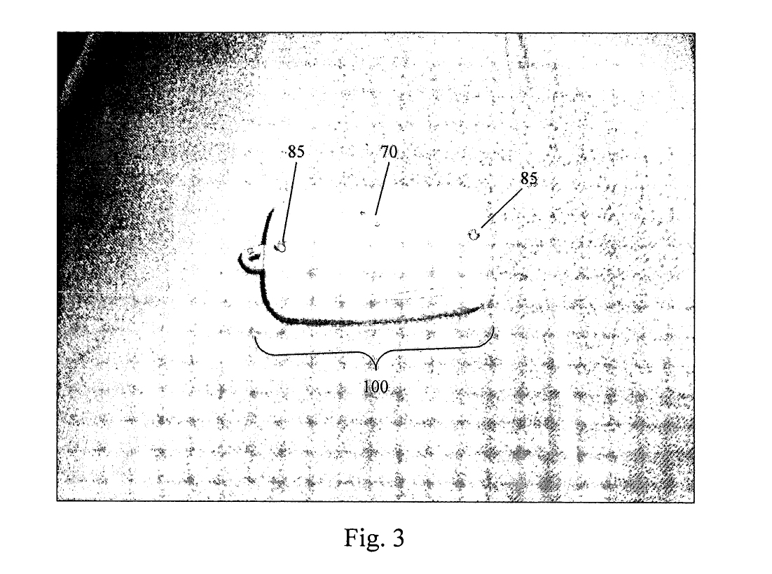

The bottom side of the present invention is on view in FIG. 3. Large button 70 is the controller for the lights in the present embodiment. Screws 85 fasten the top half to the bottom half of the invention.

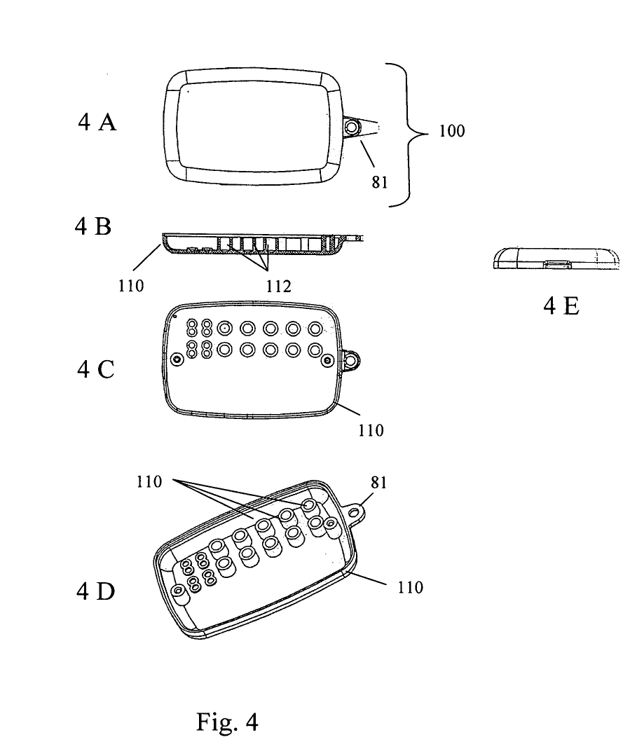

FIGS. 4A-4E display various views of the top half shell 110 of the present invention. FIG. 4A is the outline of the shell 110 without detail. FIG. 4B shows the side view of top shell 110 with the light tubes 112 shown in side section. FIG. 4 C displays the same shell 110 with the light tubes from a top view.

FIG. 4D portrays top shell 110 with the light tubes 112 delineated clearly from this top perspective view. Also shown is half loop 81, which mates to half loop 82 in the bottom shell to form a complete loop 80 for connecting a key ring to the current invention.

Finally, FIG. 4E shows top shell 110 from an end view. This view is looking straight down the half shell from the loop end.

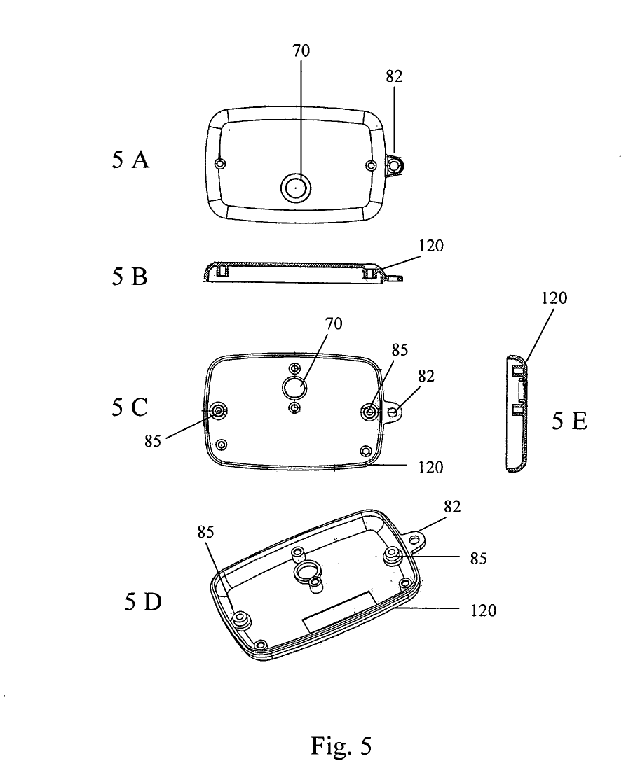

FIGS. 5A-5E display various views of the bottom half shell 120 of the present invention. FIG. 5A is the outline of the shell 120 without detail. FIG. 5B shows the side view of bottom shell 120 with the light tubes 112 shown in side section. FIG. 5C displays the same shell 120 with the controller button 70 and half loop 82 visible.

FIG. 5D portrays bottom half shell 120 with the threaded apertures 85 for connecting screws clearly from this top perspective view. Also shown is half loop 82, which mates to half loop 81 in the bottom shell to form a complete loop 80 for connecting a key ring to the current invention.

Finally, FIG. 5E shows top shell 110 from an end view. This view is looking straight down the half shell from the loop end.

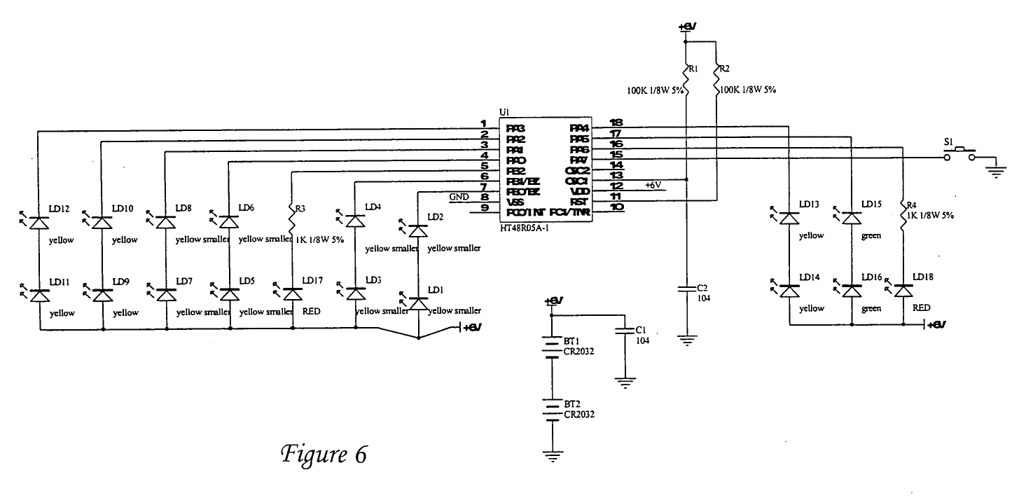

FIG. 6 shows the circuit diagram for the preferred embodiment. This is preferably mounted on a printed circuit board (not shown). The circuit board also can contain small speakers, for producing preprogrammed sounds.

The entire invention 100 is produced by sandwiching (ie, surrounding) the printed circuit board with LEDs with top shell 110 and bottom shell 120. The two halves are connected by screws at 85.

The invention is optionally comprised of removable computer chips attached to the circuit. These chips may provide the controlling action for programming the sequence in which the lights turn on. They may also store and direct the speakers to play back sounds, such as the sounds of a drag race.

In one embodiment of the current invention, the chips are removable and replaceable. This allows the lights to have a different sequence of lighting, or different sounds, simply by replacing the corresponding chip.

While the invention has been described in connection with a preferred embodiment or embodiments, it is not intended to limit the scope of the invention to the particular form set forth, but on the contrary, it is intended to cover such alternatives, modifications, and equivalents as may be included within the spirit and scope of the invention as defined by the appended claims.

I claim:

1. A lighted key fob comprising:
a power source;
a plurality of lighting elements;
a switch operating an electric circuit to operate said lighting elements;
a controller system to control the sequence of each lighting element being switched on or off; wherein
said lighting elements being turned on in sequence as determined by the operation of said controller.

2. The key fob of claim 1, wherein said controller system comprises a computer chip.

3. The key fob of claim 1, wherein said lighting elements comprise light-emitting diodes.

4. The key fob of claim 1, wherein said power source comprise at least a single battery.

5. The key fob of claim 1, wherein said lighting elements are arranged in tow parallel lines.

6. The key fob of claim 1, wherein the lighting element colors and sequence of lights mimic the light colors and sequence of lights used to start a drag race.

7. The key fob of claim 1, further comprising a miniature speaker and audio playback system based on a second computer chip with recorded sounds.

8. The key fob of claim 7, wherein the sound tones and sequence of sounds mimic the sound tones and sequence of sounds at the start of a drag race.

9. The key fob of claim 7, wherein the computer chips are exchangeable with new chips that will produce different sounds and lighting sequence.

10. A lighted key fob comprising:
a power source, comprised of batteries;
a plurality of lighting elements, comprised of LEDs;
a switch operating an electric circuit to operate said lighting elements;
a controller system to control the sequence of each lighting element being switched on or off;
said controller system comprising a computer chip capable of issuing controlling instructions;
an audio playback system, controlled by said controller system;
wherein
said lighting elements being turned on in sequence, and said sound playback system being operated as determined by the operation of said controller.
